(19) United States
(12) Patent Application Publication
(10) Pub. No.: US 2013/0059155 A1
(43) Pub. Date: Mar. 7, 2013

(54) GAS BARRIER THIN FILM, ELECTRONIC DEVICE INCLUDING THE SAME, AND METHOD OF PREPARING GAS BARRIER THIN FILM

(71) Applicants: Jae-young CHOI, Suwon-si (KR); Ho-bum PARK, Seoul (KR)

(72) Inventors: Jae-young CHOI, Suwon-si (KR); Ho-bum PARK, Seoul (KR)

(73) Assignees: Industry-University Cooperation foundation Hanyang University, Seoul (KR); SAMSUNG ELECTRONICS CO., LTD., Suwon-si (KR)

(21) Appl. No.: 13/601,646

(22) Filed: Aug. 31, 2012

(30) Foreign Application Priority Data
Sep. 1, 2011 (KR) 10-2011-0088532

(51) Int. Cl. B32B 9/04; B05D 1/38; B32B 27/06; B05D 1/36; B82Y 30/00

(52) U.S. Cl. 428/408; 427/402; 427/372.2; 977/734

(57) ABSTRACT

A gas barrier thin film may include a substrate, an inorganic oxide layer, and a graphene layer between the substrate and the inorganic oxide layer. An encapsulation thin film and electronic device may include the gas barrier thin film. A method of preparing a gas barrier thin film may include forming a graphene layer by transferring graphene on a surface of a substrate, and forming an inorganic oxide layer by depositing an inorganic oxide on the graphene layer.

### CROSS-REFERENCE TO RELATED APPLICATIONS

This application claims the benefit of Korean Patent Application No. 10-2011-0088532, filed on Sep. 1, 2011, in the Korean Intellectual Property Office, the disclosure of which is incorporated herein in its entirety by reference.

### BACKGROUND

1. Field

Example embodiments relate to a gas barrier thin film, an electronic device including the same, and/or a method of preparing the gas barrier thin film, for example, to a gas barrier thin film including a plurality of layers formed of graphene to have improved flexibility, hydrophobic properties, and transparency, an electronic device including the gas barrier thin film, and/or a method of preparing the gas barrier thin film.

2. Description of the Related Art

Organic materials used in electronic devices, e.g., organic light emitting devices (OLEDs) or liquid crystal display devices (LCDs), are highly vulnerable with respect to oxygen or moisture in the atmosphere. Thus, when organic materials are exposed to oxygen or moisture, the output and performance of electronic devices including the organic materials may drop.

A method of prolonging the lifetime of electronic devices by using a metal and glass to protect the electronic devices has been developed. However, metals are not generally transparent, and because glass is generally inflexible, glass breaks more easily.

A method of prolonging the lifetime of electronic devices by deriving a thin film including silica (SiO₂) from an organic polymer, e.g., polysilazane, to protect the electronic devices has been developed. However, the thin film derived from polysilazane is relatively hard and hydrophilic. In addition, a higher temperature equal to or greater than 400° C. is necessary to cure the thin film.

### SUMMARY

Example embodiments provide a gas barrier thin film including a plurality of layers formed of graphene. Example embodiments also provide an electronic device including the gas barrier thin film. Example embodiments also provide a method of preparing the gas barrier thin film.

Additional aspects will be set forth in part in the description which follows and, in part, will be apparent from the description, or may be learned by practice of example embodiments.

According to example embodiments, a gas barrier thin film may include a substrate, a first inorganic oxide layer, and a first graphene layer between the substrate and the first inorganic oxide layer.

According to example embodiments, an encapsulation thin film and an electronic device may include the gas barrier thin film.

According to example embodiments, a method of preparing a gas barrier thin film may include forming a graphene layer by transferring graphene on a surface of a substrate, and forming an inorganic oxide layer by depositing an inorganic oxide on the graphene layer.

According to example embodiments, a gas barrier thin film may include at least one graphene layer and at least one inorganic oxide layer on a substrate.

Accordingly, example embodiments provide a gas barrier thin film or encapsulating thin film which is flexible and transparent, prevents or reduces the penetration of moisture, and has improved transparency so as to encapsulate electronic devices, e.g., thin, light and flexible OLEDs.

### BRIEF DESCRIPTION OF THE DRAWINGS

These and/or other aspects will become apparent and more readily appreciated from the following description of the embodiments, taken in conjunction with the accompanying drawings of which:

FIG. 1 is a cross-sectional view of a gas barrier thin film according to example embodiments;

FIG. 2 is a schematic cross-sectional view of a gas barrier thin film according to example embodiments;

FIG. 3 is a schematic cross-sectional view of a gas barrier thin film according to example embodiments;

FIG. 4 is a cross-sectional view of a gas barrier thin film according to example embodiments;

FIG. 5 is a cross-sectional view of a gas barrier thin film according to example embodiments; and

FIG. 6 is a cross-sectional view of a gas barrier thin film according to example embodiments.

### DETAILED DESCRIPTION

Hereinafter, a gas barrier thin film and an electronic device including the same will be described in detail to example embodiments. As used herein, the term “and/or” includes any and all combinations of one or more of the associated listed items.

Example embodiments will hereinafter be described in further detail with reference to the accompanying drawings, in which various embodiments are shown. This disclosure may, however, be embodied in many different forms and should not be construed as limited to example embodiments set forth herein. In the drawings, the thicknesses of layers and regions are exaggerated for clarity. Like reference numerals in the drawings denote like elements, and thus their description will be omitted.

It will be understood that, although the terms “first”, “second”, etc. may be used herein to describe various elements, components, regions, layers and/or sections, these elements, components, regions, layers and/or sections are not to be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments are not to be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, is to be interpreted as having a meaning that is consistent with their meaning in the context of the relevant art and will not be interpreted in an idealized or overly formal sense unless expressly so defined herein.

A gas barrier thin film according to example embodiments may include a graphene layer between a substrate and an inorganic oxide layer.

As used herein, the “graphene” stacked on the intermediate layer refers to a polycyclic aromatic molecule including a plurality of carbon atoms linked to each other by a covalent bond. The plurality of carbon atoms may form a six-membered ring as a standard repeating unit, or may further include 5-membered rings and/or 7-membered rings. Accordingly, the graphene may be a single layer of covalently bonded carbon atoms having, in general, sp² hybridization. The graphene may have any of various structures, which may depend upon the content of 5-membered rings and/or 7-membered rings in the graphene. A plurality of graphene layers is often referred to in the art as graphite. However, for convenience, “graphene,” as used herein, may comprise one or more layers of graphene. Thus, as used herein, graphene may refer to a single layer of carbon, or also may refer to a plurality of stacked single layers of graphene.

Because the graphene has a compact structure in which six-membered rings of carbon are repeated, the graphene may prevent or reduce penetration of gas and vapor. In addition, because the graphene has only a thickness of about 0.6 nm, the graphene has improved light transmittance and flexibility. In addition, because the graphene has improved hydrophobic properties compared to a thin film formed of metal, the graphene may also prevent or reduce penetration of moisture.

Thus, a thin film including a single layer and a plurality of layers formed of the graphene may simultaneously have flexibility, light transmittance, gas barrier properties, and moisture barrier properties.

The graphene may be used to form a single layer. Alternatively, the graphene may be used to form a plurality of layers in order to increase barrier properties. When a plurality of layers are used, 2 to 100 layers, 2 to 50 layers, 2 to 20 layers, or 2 to 10 layers may be used.

The graphene layer may have various shapes and sizes and is not particularly limited. The graphene layer may have, but is not limited to, a circular shape, a rectangular shape, and/or an oval shape. The graphene layer may have a size of, but is not limited to, 1 cm×1 cm or more. In addition, the graphene layer may have a size of 10 m×10 m or more as long as manufacturing processes are permissible.

The graphene layer may be interposed between a substrate and an inorganic oxide layer. Examples of the substrate may include a polymer and/or metallic material.

The substrate and the inorganic oxide layer may have sufficient sizes to interpose the graphene layer. The substrate and the inorganic oxide layer may each have a thickness ranging from about 1 to about 10 μm or from about 10 to about 100 μm, but are not limited thereto. Within the range, sufficient light transmittance and flexibility may be ensured.

In addition, as described above, a substrate/a graphene layer/an inorganic oxide layer/a graphene layer/an inorganic oxide layer may be obtained by adding a graphene layer and an inorganic oxide layer on a thin film including a substrate/a graphene layer/an inorganic oxide layer and may be repeatedly stacked.

In such a gas barrier thin film structure, an intermediate layer may be further formed between the substrate and the graphene layer, or the graphene layer and the inorganic oxide layer. The intermediate layer may function as a stress buffer between the substrate and the inorganic oxide layer so as to prevent or reduce cracks from being generated in the substrate or the inorganic oxide layer, and may increase adhesion between the substrate and the inorganic oxide layer so as to further prevent or reduce the penetration of moisture and oxygen. In addition, the intermediate layer may facilitate regular sputtering of the inorganic oxide layer so that the inorganic oxide layer may be compactly formed to a predetermined or given thickness or more.

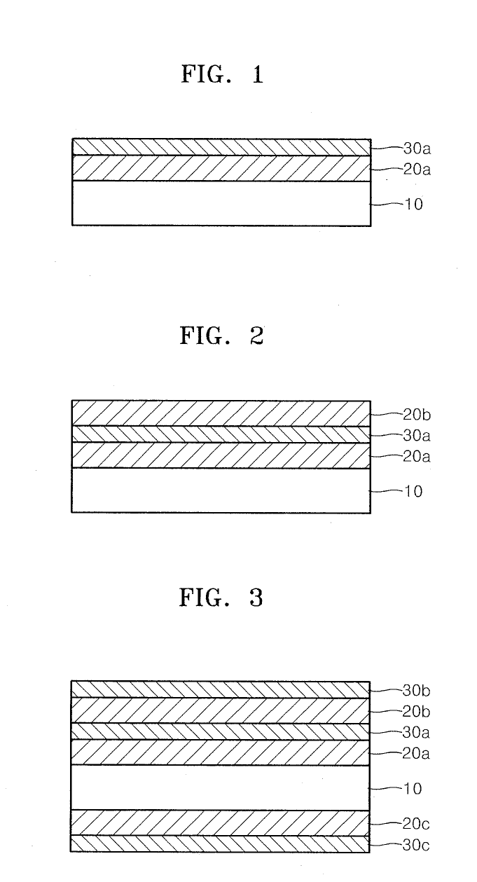

FIG. 1 is a cross-sectional view of a gas barrier thin film according to example embodiments. Referring to FIG. 1, the gas barrier thin film according to example embodiments may include a substrate 10, a first graphene layer 20a formed on the substrate 10, and a first inorganic oxide layer 30a formed on the first graphene layer 20a.

The first graphene layer 20a may be formed on the substrate 10 by transferring graphene that is separately prepared onto the substrate 10. The first inorganic oxide layer 30a may be formed by depositing organic oxide on the first graphene layer 20a by using a physical vapor deposition (PVD) apparatus. Examples of a PVD process used to form the first inorganic oxide layer 30a may include, but are not limited to, sputtering, pulsed laser deposition (PLD) ion beam deposition (IBD), or ion beam assistant deposition (IBAD).

The gas barrier thin film may have improved light transmittance equal to or greater than 70% in a visible light wavelength region, for example, light transmittance in the range of about 70 to about 90% at a wavelength equal to or greater than about 400 nm, and light transmittance in the range of about 80 to about 90% at a wavelength equal to or greater than about 500 nm. The light transmittance is suitable for achieving the purpose of example embodiments. Because all components included in the gas barrier thin film are flexible, the gas barrier thin film may have flexibility.

As described above, the gas barrier thin film may further include at least one layer selected from the group consisting of a graphene layer and an inorganic oxide layer that are alternately stacked on a surface of the substrate opposite to that on which the substrate 10 is formed, or alternatively, may further include at least one layer selected from the group consisting of a graphene layer and an inorganic oxide layer that are alternately stacked on the first inorganic oxide layer 30a.

FIGS. 2 and 3 are cross-sectional views of gas barrier thin films according to example embodiments. Referring to FIG. 2, the gas barrier thin film according to example embodiments may include the substrate 10, the first graphene layer 20a formed on the substrate 10, the first inorganic oxide layer 30a formed on the first graphene layer 20a, and a second graphene layer 20b that is formed on the first inorganic oxide layer 30a. Referring to FIG. 3, the gas barrier thin film according to example embodiments may include the substrate 10, the first graphene layer 20a formed on a surface of the substrate 10, the first inorganic oxide layer 30a formed on the first graphene layer 20a, the second graphene layer 20b formed on the first inorganic oxide layer 30a, a second inorganic oxide layer 30b formed on the second graphene layer 20b, a third graphene layer 20c formed on another surface of the substrate 10, and a third inorganic oxide layer 30c formed on the third graphene layer 20c.

By virtue of the above-described layers that are alternately stacked, the gas barrier thin films according to example embodiments illustrated in FIGS. 2 and 3 may further prevent or reduce penetration of gas and moisture.

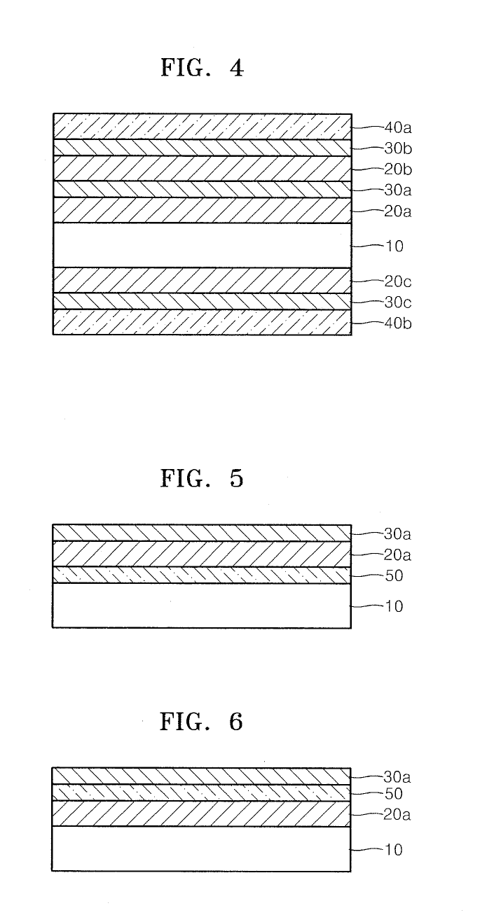

FIG. 4 is a cross-sectional view of a gas barrier thin film according to example embodiments. As shown in FIG. 4, the gas barrier thin film may further include first and second protecting layers 40a and 40b stacked on the second and third inorganic oxide layers 30b and 30c, respectively. The first and second protecting layers 40a and 40b may prevent or reduce damage to the surfaces of the second and third inorganic oxide layers 30b and 30c, respectively. The first and second protecting layers 40a and 40b may include at least one compound selected from fluorine, silicon, a hydrophobic polymer, and combinations thereof, but is not limited thereto.

In the gas barrier thin films according to example embodiments, the substrate 10 may be formed of an organic polymer or metal, and the organic polymer of the metal may have a film form and flexible. The substrate 10 may be a general substrate used in electronic devices or packing materials. Examples of organic polymers used to form the substrate 10 may include polyethylene, polypropylene, polymethyl metacrylate(PMMA), poly(N,N-dimethylacrylamide) (PDMA), poly(3,4-ethylenedioxythiophene)(PEDOT), polyoxymethylene, polyvinylnaphthalene, polyether ketone, fluoropolymer, polystyrene, polysulfone, polyphenylene oxide, polyether imide, polyether sulfone, polyamide imide, polyimide, polyphtalamide, polycarbonate, polyarylate, polyethylene naphthalate, and polyethylene terephthalate, which are used alone or in a combination of at least two thereof. Examples of metals used to form the substrate 10 may include, but are not limited to, aluminum, copper, steel, and a steel alloy in a film form.

An organic polymer and metal that are used to form the substrate 10 may be used in a combination or in a combination of at least two thereof. In the gas barrier thin film, examples of organic oxides included in the inorganic oxide layer may include, but are limited to, SiO₂, Al₂O₃, MgO, ZnO, or combinations thereof.

FIG. 5 is a cross-sectional view of a gas barrier thin film according to example embodiments. As shown in FIG. 5, an intermediate layer 50 may be further formed between the substrate 10 and the first graphene layer 20a. The intermediate layer may be formed by coating a solution obtained by dissolving, for example, a polysilazane-based polymer and/or a polysiloxane-based polymer in a solvent on the substrate 10 and curing the resulting structure. The curing may be performed before or after the transfer of the first graphene layer 20a. In particular, in order to reinforce adhesion between the first graphene layer 20a and the substrate 10, the curing may be performed after transfer of the first graphene layer 20a.

FIG. 6 is a cross-sectional view of a gas barrier thin film according to example embodiments. As shown in FIG. 6, an intermediate layer 50 may be further formed between the first graphene layer 20a and the first inorganic oxide layer 30a. The intermediate layer 50 may be formed by coating a solution obtained by dissolving, for example, a polysilazane-based polymer and/or a polysiloxane-based polymer in a solvent on the first graphene layer 20a and curing the resulting structure. The curing may be performed before or after the formation of the first inorganic oxide layer 30a.

An electronic device according to example embodiments may include the gas barrier thin film of FIGS. 1, 2, 3, 4, 5 and/or 6. The gas barrier thin film may prevent or reduce the penetration of oxygen and moisture, has improved light transmittance and flexibility, a higher tolerance with respect to diffusion of compounds and may prolong the lifetime of the electronic device when the gas barrier thin film is used as an encapsulating thin film of the electronic device.

The electronic device may be, for example, an organic light emitting device, a display device, photovoltaics, an integrated circuit, a pressure sensor, a chemical sensor, a bio sensor, a photovoltaic device, or a lighting device, but is not limited thereto.

The gas barrier thin film may be manufactured by using the following method. A thin film may be formed by preparing a graphene layer to have a predetermined or given number of layers, transferring the graphene layer on a surface of a substrate, and depositing an inorganic oxide on the graphene layer.

The graphene layer may be prepared by a general method of manufacturing a graphene layer. In detail, the graphene layer may be prepared by using the following method.

A method of preparing the graphene layer may be largely classified into a mechanical method and a chemical method.

With the mechanical method, a thin graphene sheet may be prepared by using a mechanical method using an adhesive tape. In example embodiments, the thin graphene sheet may be prepared by attaching an adhesive tape to two surfaces of the graphite particle, broadening the surfaces to two directions such that a graphite particle is divided into two parts, and repeating these processes.

With regard to the chemical method, a graphene sheet may be formed on a substrate by forming a substrate having at least one surface on which graphite catalyst is formed, allowing a carbon-based material as a carbon source to contact the substrate, performing heat treatment in an inactive atmosphere or a reduction atmosphere, and forming graphene on the graphite catalyst.

The graphite catalyst may be formed on the substrate and the carbon-based material may contact the substrate. The carbon-based material may contact the substrate by using any one method from among a process (a) of coating a carbon-containing polymer as the carbon-based material on a substrate on which a pattern is formed; a process (b) of injecting a gaseous carbon-based material as the carbon-based material into the substrate on which the pattern is formed; and a process (c) of immersing the substrate on which the pattern is formed in a liquid carbon-based material as the carbon-based material and performing a preheating treatment.

The graphite catalyst may help carbon components to be combined with each other to form a plate structure having a hexagonal shape and may be a catalyst for synthesizing graphite, inducing a carbon reaction, or preparing carbon nanotube. In more detail, the graphite metal catalyst may be at least one of nickel (Ni), cobalt (Co), iron (Fe), platinum (Pt), gold (Au), aluminum (Al), chromium (Cr), copper (Cu), magnesium (Mg), manganese (Mn), molybdenum (Mo), rhodium (Rh), silicon (Si), tantalum (Ta), titanium (Ti), tungsten (W), uranium (U), vanadium (V), and zirconium (Zr), or an alloy thereof.

In order to form the graphene, the carbon-based material that contacts the graphite catalyst may be any material containing carbon, which has any structure and composition. However, in order to form a compact graphite layer, a density of a carbon-based material coated on the graphite layer may be higher. Examples of the carbon-based material may include a hydrocarbon-based organic polymer, a vapor carbon-based material, or a liquid carbon material.

A size of the graphene obtained by using the method may be adjusted and an area of the graphene may be more easily increased by controlling an area of a substrate on which the graphite catalyst is formed. That is, a substrate having a relatively large area may be used and the size of the substrate is not particularly limited theoretically. That is, the graphite catalyst may be formed on the substrate by using various methods to obtain a graphene sheet having a relatively large area. The substrate may be, but is not limited to, a silicon substrate.

The graphene is formed and then the graphene is transferred on a substrate. In example embodiments, the substrate may be formed of a metal or organic polymer (plastic) polymer and may be a substrate of an electronic device and a substrate that is commonly used as a packing material. Examples of the organic polymer used to form the substrate may include polyethylene, polypropylene, polyvinyl chloride, polymethyl metacrylate (PMMA), poly(N,N-dimethylacrylamide) (PDMA), poly(3,4-ethylenedioxythiophene) (PEDOT), polyoxymethylene, polyvinylnaphthalene, polyether ketone, fluoropolymer, polystyrene, polysulfone, polyphenylene oxide, polyether imide, polyether sulfone, polyamide imide, polyimide, polyphtalamide, polycarbonate, polyarylate, polyethylene naphthalate, or polyethylene terephthalate, which may be used alone or in combination of at least two thereof. Examples of metals used to form the substrate may include, but are not limited to, aluminum, copper, steel, and a steel alloy. The substrate may have a thickness ranging from about 1 to about 100.

Graphene may be transferred to have a predetermined or given number of layers on at least one surface of the substrate and then an inorganic oxide layer may be formed on the graphene. An inorganic oxide layer may be formed on a graphene layer by using a physical vapor deposition (PVD) apparatus. Examples of a PVD process used to form the inorganic oxide layer may include, but are not limited to, sputtering, pulsed laser deposition (PLD) ion beam deposition (IBD), or ion beam assistant deposition (IBAD).

The inorganic oxide layer may have a thickness ranging from about 1 to about 10 μm. The graphene layer and the inorganic oxide layer may be further formed by repeating the above-described process.

An intermediate layer may be further formed between the substrate and the graphene layer, or between the graphene layer and the inorganic oxide layer.

The intermediate layer may be, but is not limited to, a cured polysilazane-based polymer and/or a cured polysiloxane-based polymer. Examples of the polysilazane-based polymer may include perhydropolysilazane, polycarbosilazone, and/or polyureasilazane. Examples of the polysiloxane-based polymer may include polydimethylsiloxane, polydiphenylsiloxane, urethane polysiloxane, acrylic polysiloxane and/or epoxy polysiloxane.

When the intermediate layer may be further formed between the substrate and the graphene, a solution obtained by dissolving a polysilazane-based polymer and/or a polysiloxane-based polymer in a solvent may be coated on the substrate and may be cured before graphene is transferred onto the substrate, or alternatively, the graphene is transferred onto the substrate and then the solution may be cured.

When the intermediate layer may be further formed between the graphene layer and the inorganic oxide layer, a solution obtained by dissolving a polysilazane-based polymer and/or a polysiloxane-based polymer in a solvent may be coated on the graphene layer, may be cured before the inorganic oxide layer is formed, and then an inorganic oxide layer may be further formed.

Examples of an organic solvent used to form a polymer solution obtained by dissolving the polysilazane-based polymer and/or the polysiloxane-based polymer may include, but are not limited to, aromatic hydrocarbons such as anisole, cyclohexane, toluene, or xylene, a ketone-based solvent such as methyl isobutyl ketone or acetone, an ether-based solvent such as tetrahydrofuran, isopropyl ether, or dibutyl ether, a silicon solvent, or a combination thereof. In the solution obtained by dissolving the polysilazane-based polymer and/or the polysiloxane-based polymer in the solvent, the polysilazane-based polymer and/or the polysiloxane-based polymer may have a solid content ranging from about 0.1 to about 90 wt %, for example, about 1 to about 40 wt %.

A mixing weight ratio of the polysilazane-based polymer and the polysiloxane-based polymer of the mixture may range from about 9:1 to about 1:2, respectively. The mixing weight ratio is suitable for achieving the purpose of example embodiments.

Examples of a method of coating an organic polymer solution on the substrate or the graphene layer may include, but are not limited to, bar coating, drop casting, spin coating, dip coating, spray coating, flow coating, and/or screen printing.

An electronic device according to example embodiments may include the gas barrier thin film of FIG. 1, 2, or 3. The gas barrier thin film may prevent or reduce the penetration of oxygen and moisture and has improved light transmittance and flexibility, and a higher tolerance with respect to diffusion of compounds and may prolong the lifetime of the electronic device when the gas barrier thin film is used as an encapsulating thin film of the electronic device. The electronic device may be, for example, an organic light emitting device, a display device, photovoltaics, an integrated circuit, a pressure sensor, a chemical sensor, a bio sensor, a photovoltaic device, or a lighting device.

An example of a photovoltaic device using the gas barrier thin film may be a dye-sensitized solar cell. The dye-sensitized solar cell includes a device including a semiconductor electrode, an electrolyte layer, and an opposite electrode. The gas barrier thin film is formed on at least one surface of the device and encapsulates the dye-sensitized solar cell so as to protect the dye-sensitized solar cell. Because the gas barrier thin film has flexibility as well as higher transparency and an improved property of preventing or reducing penetration of moisture, the gas barrier thin film may protect the dye-sensitized solar cell without adversely affecting performance of the dye-sensitized solar cell.

The semiconductor electrode, which includes a conductive transparent substrate and a light absorbing layer, may be prepared by coating a colloid solution of a nanoparticulate oxide on a conductive glass substrate, heating the resultant in a high temperature furnace, and adsorbing a dye thereon.

The conductive transparent substrate may be formed by forming a conductive transparent electrode of, for example, indium tin oxide (ITO) or fluorine-doped tin oxide (FTO) on a transparent substrate or by coating a conductive material on a transparent substrate. Examples of the transparent substrate may include a transparent polymer, for example, polyethylene terephthalate, polycarbonate, polyimide, or polyethylene naphthalate, or glass. The conductive material may be a transparent material, e.g., ITO, FTO, and tin oxide. When the conductive material is a material reflecting or absorbing light, e.g., platinum (Pt), aluminum (Al), gold (Au), silver (Ag), palladium (Pd), carbon nanotube, carbon black, or a conductive polymer, the conductive transparent substrate may be prepared by coating the conductive material to have a predetermined or given pattern instead of coating the conductive material on an entire portion of the conductive transparent substrate so as to ensure a region through which light is transmitted. This method is also applied to the opposite electrode.

To form the dye-sensitized solar cell in a bendable configuration, for example, in a cylindrical structure, the opposing electrode, in addition to the transparent electrode, may be formed of a flexible material.

The nanoparticulate oxide used in the solar cell may be a semiconductor particle, and in example embodiments, may be an n-type semiconductor, which provides an anode current as a result of conduction band electrons serving as carriers when excited by light. Examples of the nanoparticulate oxide include TiO₂, SnO₂, ZnO₂, WO₃, Nb₂O₅, Al₂O₃, MgO, and TiSrO₃. In example embodiments, the nanoparticulate oxide may be anatase-type TiO₂. The nanoparticulate oxide is not limited to these metal oxides, which may be used alone or in a combination of at least two thereof. Such semiconductor particles may have a relatively large surface area in order for the dye adsorbed on the surface of the semiconductor particles to absorb a relatively large amount of light. For this, the semiconductor particles may have an average particle diameter of 20 nm or less.

Any dye that is commonly used in solar cells or photoelectric cells can be used as the dye without limitation. In example embodiments, a ruthenium complex may be used. Examples of the ruthenium complex are RuL₂(SCN)₂, RuL₂(H₂O)₂, RuL₃ and RuL₂, wherein L is 2,2′-bipyridyl-4,4′-dicarboxylate. Any dye that has a charge separating capability and sensitization may be used as the dye 12b without limitation. Examples of the dye 12b may be a xanthine dye (e.g., rhodamine B, rose bengal, eosin and erythrosin), a cyanine dye (e.g., quinocyanine and kryptocyanine), a basic dye (e.g., phenosafranine, tyocyn and methylene blue), a porphyrin-based compound (e.g., chlorophyll, Zn porphyrin and Mg porphyrin), an azo dye, a complex (e.g., phthalocyanine and Ru trisbipyridyl), an anthraquinone-based dye and a polycyclic quinone-based dye. An anthraquinone-based dye and a polycyclic quinone-based dye that are part of a ruthenium complex may also be used. The aforementioned dyes may be used alone or in a combination of at least two thereof.

The thickness of the light absorbing layer including the nanoparticulate oxide and the dye may be about 15 micrometers (microns), for example, about 1 micron to about 15 microns. The light absorbing layer has relatively high series resistance due to its structure and the increased series resistance causes reduction in conversion efficiency. Thus, the thickness of the light absorbing layer is controlled to less than about 15 microns in order to maintain its function and to maintain the series resistance at a lower level and prevent or inhibit reduction in conversion efficiency.

The electrolyte layer used in the dye-sensitized solar cell may be a liquid electrolyte, an ionic liquid electrolyte, an ionic gel electrolyte, a polymer electrolyte and a complex thereof. The electrolyte layer is mainly formed of an electrolyte and includes the light absorbing layer. The electrolyte is infiltrated into the light absorbing layer to form the electrolyte layer. An iodide-acetonitrile solution may be used as the electrolyte, but any material that has hole transporting or conduction capability can be used without limitation.

In addition, the dye-sensitized solar cell may further include a catalyst layer (not shown). The catalyst layer facilitates oxidation and reduction reaction of the dye-sensitized solar cell. Platinum, carbon, graphite, carbon nanotubes, carbon black, p-type semiconductors and a complex thereof may be used as the catalyst. The catalyst layer is interposed between the electrolyte layer and the opposing electrode. The surface area of the catalyst may be enlarged using a microstructure. In example embodiments, platinum black may be employed for platinum catalysts and porous carbon may be employed for carbon catalysts. The platinum black may be prepared by anodizing platinum and/or treating platinum with chloroplatinic acid. The porous carbon may be prepared by sintering carbon particles and/or calcinating an organic polymer.

Because the dye-sensitized solar cell may include the gas barrier thin film that further prevents or reduces penetration of moisture and has relatively high transparency, the dye-sensitized solar cell is encapsulated by the gas barrier thin film so as to ensure durability.

According to example embodiments, the gas barrier thin film may be used as a thin film for encapsulating various display devices and may be used to form as, for example, an encapsulating thin film of an organic light emitting device.

The organic light emitting device is an active light emitting display device that emits light by recombination of electrons and holes in a thin layer made of a fluorescent or phosphorescent organic compound when a current is applied to the thin layer. An organic light emitting device according to example embodiments has a structure that includes an anode, a hole transport layer (HTL), an emission layer, an electron transport layer (ETL) and a cathode that are sequentially formed on a substrate. In order to facilitate the injection of electrons and holes, the organic light emitting device may further include an electron injection layer (EIL) and a hole injection layer (HIL). If desired, a hole blocking layer (HBL) and/or a buffer layer may further be included.

Because the organic light emitting device includes various organic materials, the organic light emitting device needs to prevent or reduce penetration of moistures. In addition, the organic light emitting device needs transparency and needs flexibility if necessary. To this end, when the organic light emitting device is encapsulated by the gas barrier thin film, the organic light emitting device may be effectively protected and may have transparency.

The HTL may be formed of, for example, polytriphenylamine, but any material that is commonly used to form a HTL may be used without limitation. The ETL may be formed of, for example, polyoxadiazole, but any material that is commonly used to form an ETL may be used without limitation.

Any fluorescent or phosphorescent materials that are commonly used in the art as an emitting material may be used to form the emission layer without limitation. In example embodiments, an additional emission material selected from the group consisting of a polymer host, a mixture of a high molecular weight host and a low molecular weight host, a low molecular weight host, and a non-radiative polymer matrix may be used. Any polymer host, any low molecular weight host, and any non-radiative polymer matrix that are commonly used to form an emission layer for an organic light emitting device may be used.

Non-limiting examples of the polymer host are poly(vinylcarbazole), polyfluorene, poly(p-phenylene vinylene) and polythiophene. Non-limiting examples of the low molecular weight host are 4,4′-N,N′-dicarbazol-biphenyl (CBP), 4,4′-bis[9-(3,6-biphenylcarbozolyl)]-1-1,1′-biphenyl{4,4′-bis[9-(3,6-biphenylcarbazolyl)]-1-1,1′-biphenyl}, 9,10-bis[(2′,7′-t-butyl)-9′,9″-(spirobifluorenyl)anthracene and tetrafluorene. Non-limiting examples of the non-radiative polymer matrix are polymethylmethacrylate and polystyrene. The emission layer may be prepared by vacuum deposition, sputtering, printing, coating, and/or an inkjet process.

When the organic light emitting device is manufactured, a particular apparatus and method are not required. The organic light emitting device may be manufactured by using a method using a light-emitting material, which is commonly used.

Hereinafter, example embodiments will be described in detail with reference to the following examples. However, these examples are not intended to limit the purpose and scope of example embodiments.

### Example 1

A Cu foil (75 μm, available from Wacopa Co.) was put in a chamber, and was then thermally treated at about 1,000° C. for about 30 minutes with a supply of H₂ at 4 sccm. After CH₄ and H₂ were further made to flow into the chamber at about 20 sccm and about 4 sccm, respectively, for about 30 minutes, the interior of the chamber was naturally cooled, thereby forming a monolayer of graphene of 10 cm×10 cm in size.

Afterward, Cu foil with the graphene sheet was coated with a 10 wt % solution of polymethylmethacrylate (PMMA) dissolved in acetone at about 1,000 rpm for about 60 seconds, and was then immersed in an etchant (Oxone®, Dow Chemical Co. Inc.) for about 1 hour to remove the Cu foil and obtain a graphene sheet attached on the PMMA. The graphene sheet attached on the PMMA was taken up to a polyethylene naphthalate (PEN) substrate (available from Dupont Teijin, a thickness of 100 μm, and a size of 10 cm×10 cm) and was dried. The PMMA was removed by acetone to obtain a thin film formed on a substrate on which a single graphene layer.

A gas barrier thin film was manufactured by forming an alumina (Al₂O₃) thin film to a thickness of 150 nm on the graphene layer by using an evaporation process apparatus (ULVAC Materials, PME-200).

### Example 2

A gas barrier thin film was manufactured in the same manner as in Example 1, except that a graphene-containing thin film including five graphene layers was formed by repeating operations in which a graphene layer attached on PMMA was stacked on a thin film on which the graphene of Example 1 is formed on a substrate and the PMMA was removed by acetone.

### Example 3

A graphene-containing thin film including five graphene layers was formed by repeating operations in which a graphene layer attached on PMMA was formed on the alumina layer of the gas barrier thin film prepared in Example 2 and the PMMA was removed by acetone.

Then, a gas barrier thin film was manufactured by depositing an alumina (Al₂O₃) thin film on the graphene layer by using a deposition process apparatus (ULVAC Materials, PME-200).

### Comparative Example 1

A gas barrier thin film was prepared by preparing a polyethyleneterephthalate (PET) substrate (thickness 200 um), depositing polyurea (PU) to a thickness of 1 um by using a PVD deposition apparatus (ULVAC Materials, PME-200), moving only a chamber in the PVD deposition apparatus, and then forming an alumina inorganic oxide layer to a thickness of 50 nm on the PET substrate.

### Comparative Example 2

A gas barrier thin film was prepared in the same manner as in Comparative Example 1 except that PU 1 um/Al₂O₃ 50 nm/PU 1 um/Al₂O₃ 50 nm were deposited in that order on the PET substrate.

### Comparative Example 3

A gas barrier thin film was prepared in the same manner as in Comparative Example 1 except that PU 1 um/Al₂O₃ 50 nm/PU 1 um/Al₂O₃ 50 nm/PU 1 um/Al₂O₃ 50 nm were deposited in that order on the PET substrate.

### Comparative Example 4

A PEN substrate (Dupont-Teijin Co. Japan, and Product name: TEONX, Q65FA-100 um) itself was used.

### Estimation Example 1

### Water Vapor Transmission Rate (WVTR)

A WVTR of each of the gas barrier thin films prepared in Examples 1 through 3 and Comparative Examples 1 through 3 was measured by using an AQUATRAN Model 1 (manufactured by MOCON) system at a temperature of 37.8° C., and at 100% RH. The results are shown in Table 1 below.

TABLE 1

| | WVTR [g/m² · day] |
|---|---|
| Example 1 | 0.001 |
| Example 2 | 0.0005 |
| Example 3 | 0.00002 |
| Comparative Example 1 | 6.5 |
| Comparative Example 2 | 0.16 |
| Comparative Example 3 | 0.07 |

As shown in Table 1, the gas barrier thin films prepared in Examples 1 through 3 exhibit increased WVTRs when compared with those in Comparative Examples 1 through 3.

### Estimation Example 2

### Visible Light Transmittance

Visible light transmittance of each of the gas barrier thin films prepared in Example 2 and Comparative Example 4 was measured by using a CARY 5000 UV-VIS Spectrometer (manufactured by VARIAN). The gas barrier thin film prepared in Example 2 exhibits a visible light transmittance in the range of about 80 to about 90%, which is similar to that of the PEN substrate itself, at a visible light wavelength equal to or greater than 500 nm

As described above, according to example embodiments, a gas barrier thin film including the graphene may prevent or reduce penetration of gas and may have higher flexibility and transparency.

It should be understood that example embodiments described herein should be considered in a descriptive sense only and not for purposes of limitation. Descriptions of features or aspects within each example embodiment should typically be considered as available for other similar features or aspects in other example embodiments.

What is claimed is:

1. A gas barrier thin film comprising:
a substrate;
a first inorganic oxide layer; and
a first graphene layer between the substrate and the first inorganic oxide layer.

2. The gas barrier thin film of claim 1, wherein the first graphene layer includes 1 to 20 graphenes.

3. The gas barrier thin film of claim 1, further comprising:
a second graphene layer and a second inorganic oxide layer on the first inorganic oxide layer.

4. The gas barrier thin film of claim 1, further comprising:
an intermediate layer between the substrate and the first graphene layer,
wherein the intermediate layer includes one of a cured polysilazane-based polymer, a cured polysiloxane-based polymer, and a combination of at least two thereof.

5. The gas barrier thin film of claim 1, further comprising:
an intermediate layer between the first inorganic oxide layer and the first graphene layer,
wherein the intermediate layer includes one of a cured polysilazane-based polymer, a cured polysiloxane-based polymer, and a combination of at least two thereof.

6. The gas barrier thin film of claim 1, wherein light transparency of the gas barrier thin film is equal to or greater than 70%.

7. The gas barrier thin film of claim 1, wherein the substrate is one of a polymer-based substrate and a metallic substrate.

8. The gas barrier thin film of claim 1, wherein the substrate includes polyethylene, polypropylene, polymethyl metacrylate (PMMA), poly(N,N-dimethylacrylamide) (PDMA), poly(3,4-ethylenedioxythiophene) (PEDOT), polyoxymethylene, polyvinylnaphthalene, polyether ketone, fluoropolymer, polystyrene, polysulfone, polyphenylene oxide, polyether imide, polyether sulfone, polyamide imide, polyimide, polyphtalamide, polycarbonate, polyarylate, polyethylene naphthalate, or polyethylene terephthalate.

9. The gas barrier thin film of claim 1, further comprising:
a protective layer on the first inorganic oxide layer.

10. The gas barrier thin film of claim 1, wherein the inorganic oxide layer includes one of SiO₂, Al₂O₃, MgO, ZnO, and a combination of at least two thereof.

11. An encapsulation thin film comprising the gas barrier thin film of claim 1.

12. An electronic device comprising the gas barrier thin film of claim 1.

13. The electronic device of claim 12, wherein the electronic device includes one of a battery, an organic light emitting device, a display device, photovoltaics, an integrated circuit, a pressure sensor, a chemical sensor, a bio sensor, a photovoltaic device, and a lighting device.

14. A method of preparing a gas barrier thin film, the method comprising:
forming a graphene layer by transferring graphene on a surface of a substrate; and
forming an inorganic oxide layer by depositing an inorganic oxide on the graphene layer.

15. The method of claim 14, prior to the forming a graphene layer, further comprising:
coating a solution on a surface of the substrate, the solution including one of a polysilazane-based polymer solution, a polysiloxane-based polymer solution, and a mixture solution of at least two thereof; and
forming an intermediate layer by curing the solution together with a transferred graphene layer.

16. The method of claim 15, prior to the forming a graphene layer, further comprising:
coating and curing the solution on the graphene layer.

17. A gas barrier thin film comprising at least one graphene layer and at least one inorganic oxide layer on a substrate.

18. The gas barrier thin film of claim 17, wherein the at least one graphene layer is between the at least one inorganic oxide layer and the substrate.

19. The gas barrier thin film of claim 17, wherein
the at least one graphene layer includes first and second graphene layers and the at least one inorganic oxide layer includes first and second inorganic oxide layers,
the first graphene layer is between the first inorganic oxide layer and the substrate, and
the second graphene layer and the second inorganic oxide layer are on the first inorganic oxide layer.

20. The gas barrier thin film of claim 17, further comprising:
an intermediate layer on one of the substrate and the at least one graphene layer,
wherein the intermediate layer includes one of a cured polysilazane-based polymer, a cured polysiloxane-based polymer, and a combination of at least two thereof.

21. The gas barrier thin film of claim 17, further comprising:
a protective layer on the at least one inorganic oxide layer.

22. An electronic device comprising the gas barrier thin film of claim 17.
